(19) United States
(12) Patent Application Publication
(10) Pub. No.: US 2025/0338247 A1
(43) Pub. Date: Oct. 30, 2025

(54) SYSTEMS AND METHODS FOR POSITIONING

(71) Applicant: ZTE CORPORATION, Shenzhen (CN)

(72) Inventors: Cong WANG, Shenzhen (CN); Chuangxin JIANG, Shenzhen (CN); Mengzhen LI, Shenzhen (CN); Qi YANG, Shenzhen (CN); Junpeng LOU, Shenzhen (CN); Fei XUE, Shenzhen (CN); Huawei ZHAO, Shenzhen (CN)

(73) Assignee: ZTE CORPORATION, Shenzhen (CN)

(21) Appl. No.: 19/261,479

(22) Filed: Jul. 7, 2025

Related U.S. Application Data
(63) Continuation of application No. PCT/CN2023/112660, filed on Aug. 11, 2023.

(51) Int. Cl. H04W 64/00; H04L 5/00

(52) U.S. Cl. CPC H04W 64/00; H04L 5/0012; H04L 5/0051

(57) ABSTRACT

Presented are systems and methods for positioning. A wireless communication device (e.g., a UE) may receive configuration information of a reference signal for positioning from a wireless communication node (e.g., a BS). The wireless communication device may send the reference signal for positioning to the wireless communication node.

### CROSS-REFERENCE TO RELATED APPLICATION

This application claims the benefit of priority under 35 U.S.C. § 120 as a continuation of International Patent Application No. PCT/CN2023/112660, filed Aug. 11, 2023, the disclosure of which is incorporated herein by reference in its entirety.

### TECHNICAL FIELD

The disclosure relates generally to wireless communications, including but not limited to systems and methods for positioning.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including various combinations of features/elements across different examples/embodiments/implementations) can be made while remaining within the scope of this disclosure.

At least one aspect is directed to a system, method, apparatus, or a computer-readable medium of the following. A wireless communication device (e.g., a UE) may receive configuration information of a reference signal for positioning from a wireless communication node (e.g., a BS). The wireless communication device may send the reference signal for positioning to the wireless communication node. The configuration information may indicate that the wireless communication device is configured to report its capability on whether the wireless communication device can perform intra-slot hopping for sending the reference signal for positioning with a specific RF re-tuning time. The configuration information may indicates that an SRS transmission occasion with hopping is configured with at least one of: a slot offset, a symbol offset, a number of symbols, or a periodicity and a corresponding offset. The configuration information may indicate that, for two slots containing first and second SRS transmission occasion, respectively, a first slot offset for the first SRS transmission occasion and second slot offset for the second SRS transmission occasion are separately configured while their respective symbol offsets are identical to each other. The configuration information may indicate that, for each hop of SRS or each transmission occasion of SRS with hopping, a periodicity and a corresponding offset is configured.

In some embodiments, the configuration information may indicate that, for one specific RedCap UE, there is at least CombSize symbol(s) between two adjacent SRS transmission occasions with hopping or between two adjacent SRS hops, where the CombSize is a Comb size of an SRS. The configuration information may indicate that symbol(s) between two adjacent SRS transmission occasions with hopping is/are not counted in determining a starting position. The configuration information may indicate that, for an SRS with hopping, if a configured number of symbols is Q, and a number of symbols for RF re-tuning is T, then there is at most floor ((Q−T)/CombSize) SRS transmission occasions with hopping within a slot, where the CombSize is a Comb size of the SRS.

In some embodiments, a wireless communication device may receive a request for Rx hopping of a reference signal for positioning from a wireless communication node. The wireless communication device may perform the Rx hopping of the reference signal for positioning measurement. The reference signal for positioning can be a positioning reference signal (PRS). The measurement can be performed within a measurement period requirement. The measurement may include at least one of: reference signal time difference (RSTD); PRS-reference signal received power (RSRP); UE Rx-Tx time difference; PRS-path RSRP (RSRPP); or carrier phase and/or carrier phase difference. The measurement period requirement can be related to at least one of: a factor H associated with hopping information; a factor H1 associated with hopping information within a PRS transmission; a factor H2 associated with a re-tunning time between adjacent hops; a factor H3 associated with a number of symbols between adjacent hops; a factor H4 associated with a number of symbols of each hop; a factor H5 associated with a PRS transmission occasion information; or a factor H6 associated with a measurement gap length and/or measurement gap repetition factor.

In some embodiments, the measurement period requirement can be determined based on the factor H associated with hopping information as: T_{meas,hop,Total}=H*T_{meas,Total} or T_{meas,hop,Total}=T_{meas,Total}+H. The measurement period in a positioning frequency layer i can be extended as: T_{meas,hop,i}=H*T_{meas,i} or T_{meas,hop,i}=T_{meas,i}+H, where meas is one of: RSTD, PRS-RSRP, UE Rx-Tx time difference, PRS-RSRPP or a carrier phase measurement; or the factor H is applied in determining the measurement period with the positioning frequency layer i. The factor H or hopping information can be a number of hops for a PRS resource. The factor H or hopping information can be related to a number of hops for a PRS resource. The factor H or hopping information can be configured by the wireless communication node. The factor H or hopping information can be reported by the wireless communication device.

In some embodiments, the measurement period requirement can be calculated according to the factor H and the factor H1 within the PRS transmission occasion. The measurement period can be calculated as: T_{meas,hop,Total}=H/H1*T_{meas,Total} or T_{meas,hop,Total}=T_{meas,Total}+H/H1 or the measurement period in a positioning frequency layer i can be extended as: T_{meas,hop,i}=H/H1*T_{meas,i} or T_{meas,hop,i}=T_{meas,i}+H/H1. Alternatively, the above factor H/H1 can be replaced by floor (H/H1) in the previous equations. meas is one of: RSTD, PRS-RSRP, UE Rx-Tx time difference, PRS-RSRPP or a carrier phase measurement; or the factor H/H1 is applied in determining the measurement period with the positioning frequency layer i; or floor (H/H1) is applied in determining the measurement period with the positioning frequency layer i. The factor H1 or hopping information within a PRS transmission can be a number of hops within the PRS transmission occasion.

In some embodiments, the factor H1 or hopping information within a PRS transmission can be configured by the wireless communication node. The factor H1 or hopping information within a PRS transmission can be reported by the wireless communication device. The measurement period requirement can be calculated according to the factor H and the factor H2 or the factor H3. The measurement period can be calculated as: T_{meas,hop,Total}=H/H2*T_{meas,Total} or T_{meas,hop,Total}=T_{meas,Total}+H/H2 or T_{meas,hop,Total}=H/H3*T_{meas,Total} Or T_{meas,hop,Total}=T_{meas,Total}+H/H3. The measurement period in a positioning frequency layer i can be extended as: T_{meas,hop,i}=H/H2*T_{meas,i} or T_{meas,hop,i}=T_{meas,i}+H/H2 or T_{meas,hop,i}=H/H3*T_{meas,i} or T_{meas,hop,i}=T_{meas,i}+H/H3. Alternatively, the above factor H/H2 or H/H3 can be replaced by floor (H/H2) or floor (H/H3). In certain embodiments, the above factor H2 or H3 can be replaced by S/H2 or S/H3, wherein S is the number of symbol configured for PRS. meas is one of: RSTD, PRS-RSRP, UE Rx-Tx time difference, PRS-RSRPP or a carrier phase measurement. The factor H/H2 or H/H3 can be applied in determining the measurement period with the positioning frequency layer i. Floor (H/H2) or floor (H/H3) can be applied in determining the measurement period with the positioning frequency layer i. S/H2 or S/H3 can be applied in determining the measurement period with the positioning frequency layer i. S is a number of symbol configured for PRS.

In some embodiments, the factor H2 or H3 or re-tunning time between adjacent hops or number of symbols between adjacent hops can be a number of symbols related to the re-tunning time. The factor H2 or H3 or re-tunning time between adjacent hops or number of symbols between adjacent hops can be configured by the wireless communication node. The factor H2 or H3 or re-tunning time between adjacent hops or number of symbols between adjacent hops is reported by the wireless communication device. The measurement period requirement can be calculated according to the factor H, the factor H2, and the factor H4. The measurement period can be calculated as: T_{meas,hop,Total}=H/(H2+H4)*T_{meas,Total} or T_{meas,hop,Total}=T_{meas,Total}+H/(H2+H4). The measurement period in a positioning frequency layer i can be expressed as: T_{meas,hop,i}=H/(H2+H4)*T_{meas,i} or T_{meas,hop,i}=T_{meas,i}+H/(H2+H4). Alternatively, the above factor H/(H2+H4) can be replaced by floor (H/(H2+H4)). In certain embodiments, the above factor H2+H4 can be replaced by S/(H2+H4), wherein S is the number of symbol configured for PRS. meas is one of: RSTD, PRS-RSRP, UE Rx-Tx time difference, PRS-RSRPP or a carrier phase measurement. The factor H/(H2+H4) can be applied in determining the measurement period with the positioning frequency layer i. Floor (H/(H2+H4)) can be applied in determining the measurement period with the positioning frequency layer i. S/(H2+H4) can be applied in determining the measurement period with the positioning frequency layer i, where S is a number of symbol configured for PRS.

In some embodiments, the factor H4 or number of symbols of each hop can be related to a configuration of a comb size. The factor H4 or number of symbols of each hop can be equal to or greater than the configuration of the comb size. The factor H4 or number of symbols of each hop can be reported by the wireless communication device. The factor H4 or number of symbols of each hop can be configured by the wireless communication node.

In some embodiments, the measurement period requirement can be calculated according to the factor H5, wherein the measurement period is calculated as: T_{meas,hop,Total}=H5*T_{meas,Total} or T_{meas,hop,Total}=T_{meas,Total}+H5 or the measurement period in a positioning frequency layer i can be expressed as T_{meas,hop,i}=H5*T_{meas,i} or T_{meas,hop,i}=T_{meas,i}+H5, where meas is one of: RSTD, PRS-RSRP, UE Rx-Tx time difference, PRS-RSRPP or a carrier phase measurement. The factor H5 can be applied in determining the measurement period with the positioning frequency layer i.

In some embodiments, the factor H5 or PRS transmission occasion information can be a number of PRS transmission occasions or a number of PRS transmission repetitions. The factor H5 or PRS transmission occasion information can be reported by the wireless communication device. The factor H5 or PRS transmission occasion information can be configured by the wireless communication node.

In some embodiments, the measurement period requirement can be calculated according to the factor H and/or the factor H6, wherein the period is calculated as: T_{meas,hop,Total}=H6*T_{meas,Total} or T_{meas,hop,Total}=T_{meas,Total}+H6 or the measurement period in a positioning frequency layer i can be expressed as: T_{meas,hop,i}=H6*T_{meas,i} or T_{meas,hop,i}=T_{meas,i}+H6. Alternatively, the above factor H6 can be replaced by H/H6 or floor (H/H6). meas is one of: RSTD, PRS-RSRP, UE Rx-Tx time difference, PRS-RSRPP or a carrier phase measurement. The factor H6 can be applied in determining the measurement period with the positioning frequency layer i. Alternatively, the above factor H6 can be replaced by H/H6 or floor (H/H6). The factor H6 can be related to a configuration of the measurement gap. The configuration of measurement gap may comprise a measurement gap length and/or a measurement gap period. The factor H6 can be reported by the wireless communication device. The factor H6 can be configured by the wireless communication node. The measurement period requirement can be related to a time-related requirement. The time-related requirement may include at least one of: a time limitation; or a parameter related to a configuration of a PRS; or a parameter related to a configuration of a measurement gap.

In some embodiments, the time-related requirement can be configured to define a measurement period requirement for frequency hopping PRS measurement. The time-related requirement can be configured by the wireless communication node.

In some embodiments, the measurement period requirement can be related a measurement capability of the wireless communication device. The measurement capability can be for frequency hopping PRS measurement. The measurement capability may indicate a duration Nₕₒₚ of DL-PRS symbols in units of ms that the wireless communication device can process every Tₕₒₚ ms assuming maximum DL-PRS bandwidth provided in supported BandwidthPRS for frequency hopping PRS measurement. The value of Nₕₒₚ can be configured smaller than a PRS processing capability without hopping, and the value of Tₕₒₚ can be larger than the PRS processing capability without hopping. Nₕₒₚ and Tₕₒₚ can be applied to the calculation of measurement period requirement. The measurement period of RSTD in positioning frequency layer i can be calculated as

$${T}_{RSTD , i} = ( \begin{matrix}{k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{{N}_{hop}} ⌉ * {N}_{sample} - 1\end{matrix} ) * {T}_{effect , i} + {T}_{last , i}$$

$${T}_{effect , i} = ⌈ \frac{{T}_{hop}}{{T}_{available\_PRS , i}} ⌉ * {T}_{available\_PRS , i} .$$

In some embodiments, the measurement period requirement can be applied for RRC_CONNECTED state or RRC_INACTIVE or RRC_IDLE state. The request for Rx hopping may comprise a measurement requirement. The measurement requirement can be a measurement period requirement. The measurement requirement includes at least one of: a time limitation; or a parameter related to a configuration of a PRS; or a parameter related to a configuration of a measurement gap. The time limitation can be a time duration in unit of millisecond. The parameter related to a configuration of a PRS can be a number of PRS periodicities. The parameter related to a configuration of a measurement gap can be a number of measurement gap repetitions.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example positioning reference signal (PRS) hopping, in accordance with some embodiments of the present disclosure;

FIG. 4 illustrates an example positioning reference signal (PRS) hopping, in accordance with some embodiments of the present disclosure;

FIG. 5 illustrates an example positioning reference signal (PRS) hopping, in accordance with some embodiments of the present disclosure;

FIG. 6 illustrates an example positioning reference signal (PRS) hopping, in accordance with some embodiments of the present disclosure;

FIG. 7 illustrates an example positioning reference signal (PRS) hopping, in accordance with some embodiments of the present disclosure;

FIG. 8 illustrates an example positioning reference signal (PRS) hopping, in accordance with some embodiments of the present disclosure;

FIG. 9 illustrates an example positioning reference signal (PRS) hopping, in accordance with some embodiments of the present disclosure;

FIG. 10 illustrates an example positioning reference signal (PRS) hopping, in accordance with some embodiments of the present disclosure;

FIG. 11 illustrates an example positioning reference signal (PRS) hopping, in accordance with some embodiments of the present disclosure; and

FIG. 12 illustrates a flow diagram of an example method for positioning, in accordance with an embodiment of the present disclosure.

### DETAILED DESCRIPTION

### 1. Mobile Communication Technology and Environment

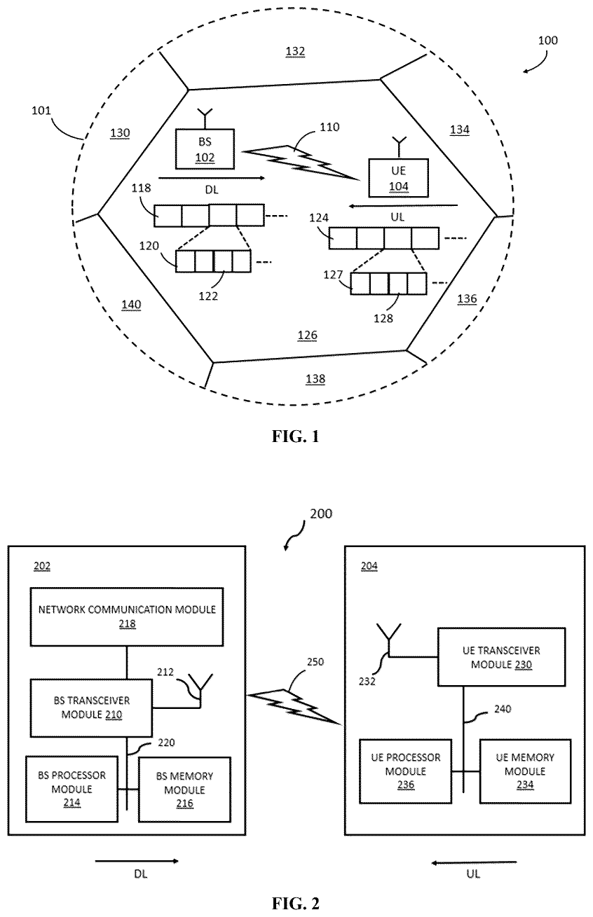

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (CNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Positioning

For timing based positioning methods, the positioning accuracy highly relies on PRS bandwidth. However, for reduced capability (RedCap) UEs, the support maximum bandwidth is limited, e.g., RedCap UEs only support 20 MHz in FRI and 100 MHz in FR2. However, the current specification prescribed PRS can be configured with larger transmission bandwidth to achieve high positioning accuracy. How to improve the positioning accuracy and keep low cost for this kind of UEs can be investigated. Some solutions are proposed to support PRS frequency hopping with K PRB overlapping between adjacent frequency hops for the sake of equivalent large bandwidth PRS and mitigating phase noise impact. However, in a positioning process, RedCap UEs may require extra switching time to sounding or monitoring PRS in different hops. Therefore, a corresponding UE capability together with measurement period can be utilized for RedCap UEs.

Some parameters (such as the inter-slot repetition factor) for PRS reception can be supported, for example, dl-PRS-ResourceRepetitionFactor defines how many times each DL-PRS resource is repeated for a single instance of the DL-PRS resource set and takes values Tᵣₑₚ^{PRS}_{∈{}1, 2, 4, 6, 8, 16, 32}. All the DL PRS resources within one resource set may have the same resource repetition factor. For PRS reception with hopping, some of the hopping parameters can be considered to enable accurate positioning for RedCap UEs.

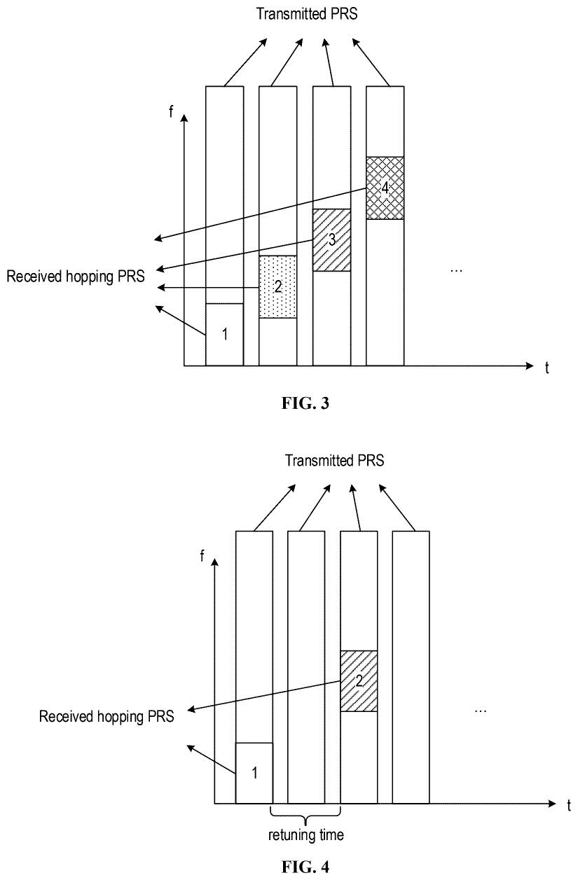

The concept of RedCap UE can be proposed to meet the requirements of specific application scenarios by reducing terminal air interface capacity, reducing complexity, and achieving requirements such as cost reduction and power consumption reduction. In positioning agenda item, RedCap UE can be supposed to sounding PRS with different hops. As shown in FIG. 3, the transmitted PRS may have large bandwidth (for example, 100 Mhz), the RecCap UE can only monitor and process the transmitted PRS with limited bandwidth (for example, 20 Mhz).

However, limited to monitor and processing capability, as shown in FIG. 4, short switching time to allow RF retuning between adjacent hops can be utilized for RedCap UE to measure the received hopping PRS. The requirements for reference signal timing difference (RSTD), PRS-reference signal received power (RSRP), UE Rx-Tx time difference, PRS-path reference signal received power (RSRPP) and carrier phase/carrier phase difference measurement for RedCap UE can be defined considering the retuning time for PRS hopping. In the following implementation examples, the PRS transmission occasion can be a PRS repetition, a PRS period, a PRS sample, or a PRS instance.

### Implementation Example 1

When physical layer receives last of ProvideAssistanceData message and RequestLocationInformation message, the RedCap UE may be able to measure RSTD, RSRP, RSRPP, RTT and/or carrier phase/carrier phase difference measurements during the measurement period.

For the number of hops of a PRS resource, the following signaling can be considered. The gNB/location management function (LMF) may configure the number of hops of a PRS resource to UE, or UE report the number of supporting frequency hops to network, or a factor associated with the number of hops, denoted as H. Alternatively, the UE can report the bandwidth for PRS reception of each hop (denote as B1) and/or gNB/LMF configures the transmission bandwidth for each PRS resource (denote as B2), the number of hops of a PRS resource can be calculated as H=[B₂/B₁]. If overlapping PRB(s) between adjacent hops is reported by a UE, the number of hops H can be updated accordingly. As shown in FIG. 5, frequency hopping of PRS can be executed in different PRS transmission occasions/PRS repetitions. In some cases, the frequency hopping of PRS reception only occurs in different PRS repetitions, e.g., inter PRS repetition.

In some cases, the frequency hopping of PRS reception occurs in different PRS repetitions as well as within one PRS repetition, e.g., intra-PRS repetition. FIG. 6 shows hopping in inter-PRS repetition and intra-PRS repetition.

The measurement period requirement T_{meas,hop,Total} can be defined as: T_{meas,hop,Total}=H*T_{meas,Total} or T_{meas,hop,Total}=T_{meas,Total}+H. meas can be RSTD, PRS-RSRP, UE Rx-Tx time difference, PRS-RSRPP and carrier phase/carrier phase difference measurement. H can be the number of hops of a PRS resource or a factor related to the number of hops of a PRS resource. For example,

$${T}_{RSTD , hop , Total} = H * {T}_{RSTD , Total} . \\ or {T}_{RSTD , hop , Total} = {T}_{RSTD , Total} + H . \\ {T}_{RSTD , Total} = {\sum }_{i = 1}^{L} {T}_{RSTD , i} + ( L - 1 ) * {max}_{i = 1}^{L} ( {T}_{effect , i} ) .$$

Alternatively, the measurement period in positioning frequency layer i can be extended as T_{meas,hop,i}=H*T_{meas,i} or T_{meas,hop,i}=T_{meas,i}+H. meas can be RSTD, PRS-RSRP, UE Rx-Tx time difference, PRS-RSRPP and carrier phase measurement. For example,

$${T}_{RSTD , hop , i} = H * {T}_{RSTD , i} or {T}_{RSTD , hop , i} = {T}_{RSTD , i} + H . \\ {T}_{RSTD , i} = ( \begin{matrix}{k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

The factor H can be applied to the calculation on the measurement period in positioning frequency layer i, specifically, the measurement period in positioning frequency layer i can be updated as follows.

### For RSTD:

$${T}_{RSTD , i} = ( \begin{matrix}H * {k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

### For PRS-RSRP/PRS-RSRPP:

$${T}_{PRS - RSRP , i} = ( \begin{matrix}H * {CSSF}_{i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last} .$$

### For Rx-Tx Time Difference:

$${T}_{UERxTx , i} = ( \begin{matrix}H * {k}_{multiTEG , i} * {CSSF}_{i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

The measurement period in RRC_INACTIVE and/or RRC_CONNECTED and/or RRC_IDLE state can be updated, e.g., with factor H associated with Rx hopping information applied to the calculation in a similar way.

The RedCap UE may report the UE capability on PRS measurement. The capability may comprise one or more of the following: the PRS processing capability; retuning time for adjacent hop; number of symbols between adjacent hops; number of symbols of each hop; indication on whether perform hopping within a PRS transmission occasion; or number of hops within a PRS transmission occasion.

The PRS processing capability may indicate the duration N of DL-PRS symbols in units of ms a UE can process every T ms assuming maximum DL-PRS bandwidth provided in supported BandwidthPRS, retuning time for adjacent hop refers to the switching time to allow RF retuning between adjacent hops, number of hops within a PRS transmission occasion refers to the number of hops that UE received within a PRS transmission occasion, e.g., a single PRS repetition or sample, or instance.

The network may configure one or more of the following parameters to UE: a factor H associated with hopping information; a parameter H1 associated with hopping information within a PRS transmission; a parameter H2 associated with retunning time between adjacent hops; a parameter H3 associated with number of symbols between adjacent hops; a parameter H4 associated with number of symbols of each hop; a parameter H5 associated with PRS transmission occasion; or a factor H6 associated with measurement gap length and/or measurement gap period. Alternatively, the UE may also report the above parameters to the network.

### Implementation Example 2: Measurement Related to H and H1

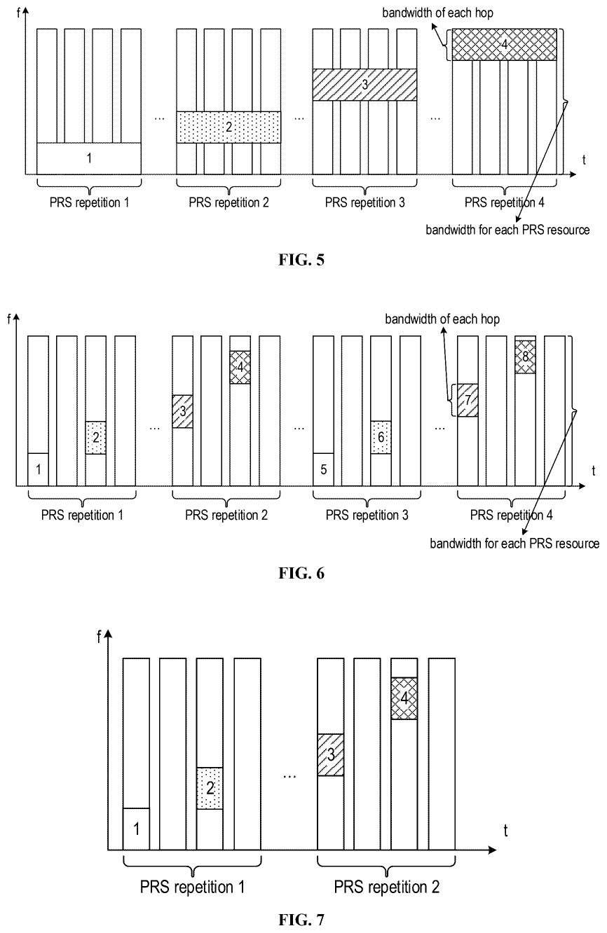

If there is no new PRS processing capability dedicated for PRS hopping, e.g., the PRS processing capability is the same as duration Of PRS-Processing without hopping. The reported number of hops or a factor associated with the hop information (denote as H1) within a PRS transmission occasion/repetition can be used to calculate the required measurement period. An example is shown in FIG. 7, in this example, the number of hops within a PRS transmission occasion/repetition is H1=2. Alternatively, the number of hops within a PRS transmission occasion can be configured by gNB/LMF to a RedCap UE, or reported by a UE to the network.

If the number of configured hops is unequal to the reported hops, H1 may take the smaller value between these two values.

The measurement period T_{meas,hop,Total} can be defined as: T_{meas,hop,Total}=H/H1*T_{meas,Total} Of T_{meas,hop,Total}=T_{meas,Total}+H/H1. meas can be RSTD, PRS-RSRP, UE Rx-Tx time difference, PRS-RSRPP and carrier phase measurement. For example,

$${T}_{RSTD , hop , Total} = H / H 1 * {T}_{RSTD , Total} or$$

$${T}_{RSTD , hop , Total} = {T}_{RSTD , Total} + H / H 1.$$

$${T}_{RSTD , Total} = {\sum }_{i = 1}^{L} {T}_{RSTD , i} + ( L - 1 ) * {max}_{i = 1}^{L} ( {T}_{effect , i} ) .$$

Alternatively, the measurement period in positioning frequency layer i can be extended as T_{meas,hop,i}=H/H1*T_{meas,i} or T_{meas,hop,i}=T_{meas,i}+H/H1. meas can be RSTD, PRS-RSRP, UE Rx-Tx time difference, PRS-RSRPP and carrier phase measurement. For example,

$${T}_{RSTD , hop , i} = H / H 1 * {T}_{RSTD , i} or$$

$${T}_{RSTD , hop , i} = {T}_{RSTD , i} + H / H 1.$$

$${T}_{RSTD , i} = ( \begin{matrix}{k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

The factor H/H1 can be applied to the calculation on the measurement period in positioning frequency layer i, specifically, the measurement period in positioning frequency layer i can be updated as follows.

### For RSTD:

$${T}_{RSTD , i} = ( \begin{matrix}H / H 1 * {k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

### For PRS-RSRP/PRS-RSRPP:

$${T}_{PRS - RSRP , i} = ( \begin{matrix}H / H 1 * {CSSF}_{i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last} .$$

For Rx-Tx time difference:

$${T}_{UERxTx , i} = ( \begin{matrix}H / H 1 * {k}_{multiTEG , i} * {CSSF}_{i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

Alternatively, the above factor H/H1 can be replaced by floor (H/H1).

### Implementation Example 3: Measurement Related to H and H2/H3

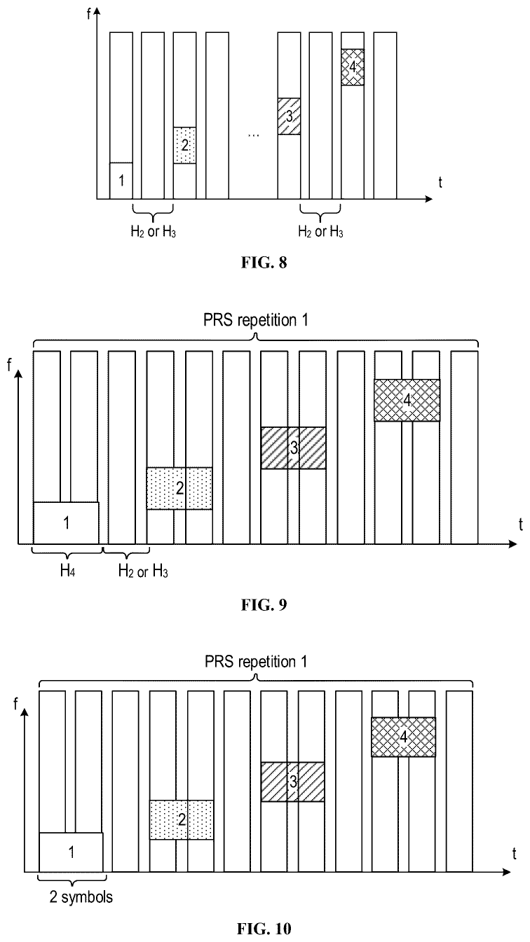

The reported Retuning time or a factor associated with retuning time (if reported, denote as H2, in units of number of symbol) for adjacent hop can be used to calculate the required measurement period. Alternatively, the reported number of symbols between adjacent hops or a factor associated with the number of symbols between adjacent hops (if reported, denote as H3), in units of number of symbol) can be used to calculate the required measurement period. An example is shown in FIG. 8, in this example, the retuning time for adjacent hop or the number of symbols between adjacent hops can be equal to 1, i.e., H2=1, H3=1. And the number of hops within a PRS transmission occasion can be calculated as └S/(H2)┘ or └S/(H3)┘, where S is the number of PRS symbol in current transmission occasion (in this example, S=4).

The (factors associated with) retuning time and/or number of symbols between adjacent hops can also be configured by the network.

The measurement period T_{meas,hop,Total} can be defined as: T_{meas,hop,Total}=H/H2*T_{meas,Total} or T_{meas,hop,Total}=T_{meas,Total}+H/H2 or T_{meas,hop,Total}=H/H3*T_{meas,Total} or T_{meas,hop,Total}=T_{meas,Total}+H/H3. meas can be RSTD, PRS-RSRP, UE Rx-Tx time difference, PRS-RSRPP and carrier phase measurement. For example,

$${T}_{RSTD , hop , Total} = H / H 2 * {T}_{RSTD , Total} or$$

$${T}_{RSTD , hop , Total} = {T}_{RSTD , Total} + H / H 2.$$

$${T}_{RSTD , Total} = {\sum }_{i = 1}^{L} {T}_{RSTD , i} + ( L - 1 ) * {max}_{i = 1}^{L} ( {T}_{effect , i} ) .$$

Alternatively, the measurement period in positioning frequency layer i can be extended as T_{meas,hop,i}=H/H2*T_{meas,i} or T_{meas,hop,i}=T_{meas,i}+H/H2 or T_{meas,hop,i}=H/H3*T_{meas,i} or T_{meas,hop,i}=T_{meas,i}+H/H3. meas can be RSTD, PRS-RSRP, UE Rx-Tx time difference, PRS-RSRPP and carrier phase measurement. For example,

$${T}_{RSTD , hop , i} = H / H 2 * {T}_{RSTD , i} + {T}_{RSTD , hop , i} = {T}_{RSTD , i} + H / H 2.$$

$${T}_{RSTD , i} = ( \begin{matrix}{k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

The factor H/H2 can be applied to the calculation on the measurement period in positioning frequency layer i, specifically, the measurement period in positioning frequency layer i can be updated as follows.

### For RSTD:

$${T}_{RSTD , i} = ( \begin{matrix}H / H 2 * {k}_{multiTEG , i} * {CSSF}_{PRS , i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last , i} .$$

### For PRS-RSRP/PRS-RSRPP:

$${T}_{PRS - RSRP , i} = ( \begin{matrix}H / H 2 * {CSSF}_{i} * ceil ( {K}_{p , PRS , i} ) * {N}_{RxBeam , i} * \\ ⌈ \frac{{N}_{PRS , i}^{slot}}{{N}^{′}} ⌉ ⌈ \frac{{L}_{available\_PRS , i}}{N} ⌉ * {N}_{sample} - 1\end{matrix} ) * {T}_{effect , i} + {T}_{last} .$$

For Rx-Tx time difference:

$${T}_{UERxTx , i} = ( H / H 2 * {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last , i} .$$

Alternatively, the above factor H/H2 or H/H3 can be replaced by floor (H/H2) or floor (H/H3). The above factor H2 or H3 can be replaced by S/H2 or S/H3, where S is the number of symbol configured for PRS.

Alternatively, the reported number of symbols between adjacent hops or a factor associated with the number of symbols between adjacent hops may include the number of symbols of each hop, i.e., symbol index difference between two hops. In this condition, in FIG. 8, the number of symbols between adjacent hops can be equal to 2, i.e., index difference between hop 1 and hop 2, H3=2.

### Implementation Example 4

The reported Retuning time or a factor associated with retuning time (if reported/configured, denote as H2, in units of number of symbol) for adjacent hop, or the reported number of symbols between adjacent hops or a factor associated with the number of symbols between adjacent hops (if reported/configured, denote as H3, in units of number of symbol), and the number of symbols of each hop or a factor associated with the number of symbols of each hop (if reported/configured, denote as H4, in units of number of symbol) can be used to calculate the required measurement period. An example is shown in FIG. 9, in this example, the retuning time for adjacent hop or the number of symbols between adjacent hops is equal to 1, e.g., H2 or H3=1, H4=2. And the number of hops within a PRS transmission occasion can be calculated as └S/(H2+H4)┘, where S is the number of PRS symbol in current transmission occasion (in this example, S=12, └S/(H2+H4)┘=4). FIG. 9 shows a PRS hopping considering Retuning time between hops and required number of slots of each hop.

The measurement period T_{meas,hop,Total} can be defined as (take H2 as an example, H2 and H3 can be replaced with each other): T_{meas,hop,Total}=H/(H2+H4)*T_{meas,Total} or T_{meas,hop,Total}=T_{meas,Total}+H/(H2+H4). meas can be RSTD, PRS-RSRP, UE Rx-Tx time difference, PRS-RSRPP and carrier phase measurement. For example, T_{RSTD,hop,Total}=H/(H2+H4)*T_{RSTD,Total} or T_{RSTD,hop,Total}=T_{RSTD,Total}+H/(H2+H4) . . .

$${T}_{RSTD , Total} = {\sum }_{i = 1}^{L} {T}_{RSTD , i} + ( L - 1 ) * {max}_{i = 1}^{L} ( {T}_{effect , i} ) .$$

Alternatively, the measurement period in positioning frequency layer i can be extended as T_{meas,hop,i}=H/(H2+H4)*T_{meas,i} or T_{meas,hop,i}=T_{meas,i}+H/(H2+H4). meas can be RSTD, PRS-RSRP, UE Rx-Tx time difference, PRS-RSRPP and carrier phase measurement. For example, T_{RSTD,hop,i}=H/(H2+H4)*T_{RSTD,i} or

$${T}_{RSTD , hop , i} = {T}_{RSTD , i} + H / ( H 2 + H 4 ) \cdot {T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last , i} .$$

$${T}_{RSTD , i} = ( H / ( H 2 + H 4 ) * {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last , i} .$$

The factor H/(H2+H4) can be applied to the calculation on the measurement period in positioning frequency layer i, specifically, the measurement period in positioning frequency layer i can be updated as follows.

### For RSTD:

### For PRS-RSRP/PRS-RSRPP:

$${T}_{PRS - RSTD , i} = ( H / ( H 2 + H 4 ) * {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last} .$$

### For Rx-Tx Time Difference:

$${T}_{UERxTx , i} = ( H / ( H 2 + H 4 ) * {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last , i} .$$

Alternatively, the above factor H/(H2+H4) can be replaced by floor (H/(H2+H4)). The above factor H2+H4 can be replaced by S/(H2+H4) or floor (S/(H2+H4)), where S is the number of symbol configured for PRS.

Alternatively, the reported number of symbols between adjacent hops or a factor associated with the number of symbols between adjacent hops may include the number of symbols of each hop, i.e., symbol index difference between two hops. In this condition, in FIG. 9, the number of symbols between adjacent hops can be equal to 3, i.e., index difference between hop 1 and hop 2, H3=3, and H3=H2+H4.

### Implementation Example 5

If there is new PRS processing capability dedicated for PRS hopping, e.g., the PRS processing capability is the different from the durationOfPRS-Processing without hopping, e.g., a new UE capability can be defined as:

$$durationOfPRS - Processing - hopping SEQUENCE \{ durationOfPRS - ProcessingSymbols ENUMERATED \{ nDot 125 , nDot 25 , nDot 5 , n 1 , n 2 , n 4 , n 6 , n 8 , n 12 , n 16 , n 20 , n 25 , n 30 , n 32 , n 35 , n 40 , n 45 , n 50 \} , durationOfPRS - ProcessingSymbolsInEveryTms ENUMERATED \{ n 8 , n 16 , n 20 , n 30 , n 40 , n 80 , n 160 , n 320 , n 640 , n 1280 \} , … \}$$

durationOfPRS-Processing-hopping can be included in LPP, or more specifically, in NR-DL-PRS-ProcessingCapability, which may indicate the duration Nₕₒₚ of DL-PRS symbols in units of ms a UE can process every Tₕₒₚ ms assuming maximum DL-PRS bandwidth provided in supported BandwidthPRS. The value of Nₕₒₚ can be configured smaller than the PRS processing capability without hopping, and the value of Tₕₒₚ can be configured larger than the PRS processing capability without hopping.

The measurement period of RSTD in positioning frequency layer i can be calculated as

$${T}_{RSTD , i} = ( {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last , i} .$$

### For PRS-RSRP/PRS-RSRPP:

$${T}_{PRS - RSTD , i} = ( {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} + {T}_{last} .$$

For Rx-Tx time difference:

$${T}_{UERxTx , i} = ( {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * {N}_{sample} - 1 ) * {T}_{effect , i} \cdot {T}_{effect , i} = ⌈ \frac{{T}_{hop}}{{T}_{avaiable \_ PRS , i}} ⌉ * {T}_{avaiable \_ PRS , i} .$$

Tₕₒₚ corresponds to durationOfPRS-ProcessingSymbolsInEveryTms as defined in durationOfPRS-Processing-hopping, Nₕₒₚ corresponds to durationOfPRS-ProcessingSysmbols as defined in durationOfPRS-Processing-hopping.

Alternatively, The measurement period of RSTD in positioning frequency layer i can be calculated as

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{H * {N}_{hop}} ⌉ * {N}_{sample} - 1 ) * {T}_{effect , i} + {T}_{last , i} .$$

### For PRS-RSRP/PRS-RSRPP:

$${T}_{PRS - RSTD , i} = ( {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{H * {N}_{hop}} ⌉ * {N}_{sample} - 1 ) * {T}_{effect , i} + {T}_{last} .$$

### For Rx-Tx Time Difference:

$${T}_{UERxTx , i} = ( {k}_{multiTEG , i} * {CSSF}_{i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{H * {N}_{hop}} ⌉ * {N}_{sample} - 1 ) * {T}_{effect , i} \cdot {T}_{last , i} .$$

H is the number of hops of a PRS resource. Nₕₒₚ corresponds to durationOfPRS-ProcessingSysmbols as defined in durationOfPRS-Processing-hopping.

Similarly, the parameters {N,T} in measurement period of PRS-RSRP, Rx-Tx timing difference, PRS-RSRPP, and carrier phase measurement can also be updated with reported UE capability with hopping {Nₕₒₚ·Tₕₒₚ}.

The measurement period requirement can be dedicated for RedCap UE, which captures the capability for RedCap UE.

### Implementation Example 6

The gNB/LMF may configure one or more of the following parameters to UE, for specifying the UE measurement requirement on PRS: factor associated with hopping information; PRS transmission occasion; factor associated with measurement gap length and/or measurement gap period; frequency hopping PRS reception requirement information; number of symbols for each hop; or retuning/switching timing information.

Specifically, if the parameters are configured by LMF, the above mentioned information can be included in LPP, more specifically, in request location information. If the parameters are configured by a gNB, the above mentioned information can be included in RRC signaling.

The factor associated with hopping information can be the number of supporting frequency hops, or a scaling factor associated with the number of hops, denoted as H.

The measurement period T_{meas,hop,Total} for UE can be defined as: T_{meas,hop,Total}=H*T_{meas,Total} or T_{meas,hop,Total}=T_{meas,Total}+H. H is the number of hops of a PRS resource or a factor related to the number of hops of a PRS resource.

Alternatively, the measurement period in positioning frequency layer i can be extended as T_{meas,hop,i}=H*T_{meas,i} or T_{meas,hop,i}=T_{meas,i}+H. meas can be RSTD, PRS-RSRP, UE Rx-Tx time difference, PRS-RSRPP and carrier phase measurement.

The PRS transmission occasion can be the number of PRS transmission occasions or number of PRS transmission repetitions for UE to sounding or received or process the required frequency hopping PRS, or a factor associated with the number of PRS transmission occasions with hopping, denote as H5. For example, if H=6, H5=3, the UE has to process 6 hops within 3 PRS transmission occasions or 3 repetitions. Alternatively, the PRS transmission occasion can be associated with the configuration of PRS, more specifically, associated with the repetition factor of PRS. The number of PRS transmission occasions can be equal to the repetition factor of PRS. Alternatively, the number of PRS transmission occasions can be smaller than or greater than the repetition factor of PRS.

The measurement period T_{meas,hop,Total} for UE can be defined as: T_{meas,hop,Total}=H5*T_{meas,Total} or T_{meas,hop,Total}=T_{meas,Total}+H5.

Alternatively, the measurement period in positioning frequency layer i can be extended as T_{meas,hop,i}=H5*T_{meas,i} or T_{meas,hop,i}=T_{meas,i}+H5. meas can be RSTD, PRS-RSRP, UE Rx-Tx time difference, PRS-RSRPP and carrier phase measurement.

Factor associated with measurement gap length and/or measurement gap period refers to a factor F related to the configuration of measurement gap. For example, the UE can process X hops within in a measurement gap length, the required number of measurement gap periods can be H/X, the factor H6 can equal to [H/X].

Frequency hopping PRS reception requirement information can be the UE processing requirement for hopping PRS in time domain. The configured PRS reception requirement information can be associated with measurement gap configuration, for example, this parameter can limit the UE can process a certain number of hops or execute Rx hopping within a certain number of measurement gap periods H6.

The measurement period T_{meas,hop,Total} for UE can be defined as: T_{meas,hop,Total} H6*T_{meas,Total} or T_{meas,hop,Total}=T_{meas,Total}+H6.

=

Alternatively, the measurement period in positioning frequency layer i can be extended as T_{meas,hop,i}=H6*T_{meas,i} or T_{meas,hop,i}=T_{meas,i}+H6. meas can be RSTD, PRS-RSRP, UE Rx-Tx time difference, PRS-RSRPP, carrier phase and carrier phase difference measurement.

The measurement period in positioning frequency layer i can be extended as

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * H 6 * {N}_{sample} - 1 ) * {T}_{effect , i} + {T}_{last , i} .$$

meas can be RSTD, PRS-RSRP, UE Rx-Tx time difference, PRS-RSRPP,carrier phase and carrier phase difference measurement.

Alternatively, the above factor H6 can be replaced by H/H6 or floor (H/H6).

Alternatively, the configured PRS reception requirement information or the request of Rx hopping can include a time requirement. For example, this parameter can limit that the UE should process a certain number of hops within Xms.

Alternatively, the configured PRS reception requirement information or the request of Rx hopping can include a parameter associated with the configuration of PRS. For example, this parameter can limit the UE should process a certain number of hops or PRS within a certain number of PRS transmission periods E. For example, if the periodicity of PRS is X, the configured/requested number of PRS periodicity is E, the time duration for UE measurement is X*E.

Alternatively, the configured PRS reception requirement information or the request of Rx hopping can include a parameter associated with the configuration of measurement gap. For example, this parameter can limit the UE should process a certain number of hops or PRS within a certain number of measurement gap repetitions. For example, if the repetition factor of measurement gap is X, the configured/request number of measurement gap is F, the time duration for UE measurement is X*F.

Number of symbols for each hop indicates the specific number of symbols of each hop for PRS reception can be configured by the network, denote as H4. For example, FIG. 10 is an example configuring number of symbols for each hop as 2. FIG. 10 shows PRS hopping considering the number of symbols of each hop.

Retuning/switching timing information can be configured by the network, indicating the Retuning time between adjacent hops. For example, the retuning time can be configured in units of number of symbol, denote as H2. And the number of hops within a PRS transmission occasion can be calculated as └S/(H4+H2)┘ or └(S+H2)/(H4+H2)┘, where S is the number of PRS symbol in current transmission occasion (in this example, S=12, └S/(H4+H2)┘=4).

The measurement period T_{meas,hop,Total} can be defined as: T_{meas,hop,Total}=H/└S/(H4+H2)┘*T_{meas,Total} Of T_{meas,hop,Total}=T_{meas,Total}+H/└S/(H4+H2)┘.

$${T}_{meas , hop , Total} = H / ⌊ ( S + H 2 ) / ( H 4 + H 2 ) ⌋ * {T}_{meas , Total} or {T}_{meas , hop , Total} = {T}_{meas , Total} + H / ⌊ ( S + H 2 ) / ( H 4 + H 2 ) ⌋$$

Alternatively, the measurement period in positioning frequency layer i can be extended as follows.

T_{meas,hop,i}=H/└S/(H4+H2)┘*T_{meas,i} or T_{meas,hop,i}=T_{meas,i}+H/└S/(H4+H2)┘ or T_{meas,hop,i}=H/└(S+H2)/(H4+H2)┘*T_{meas,i} or T_{meas,hop,i}=T_{meas,i}+H/└(S+H2)/(H4+H2)┘. meas can be RSTD, PRS-RSRP, UE Rx-Tx time difference, PRS-RSRPP and carrier phase measurement.

With the above implementation examples, the measurement for PRS can be determined with hopping related information or timing requirement. The measurement period requirement can be more reasonable for RedCap UEs.

### Implementation Example 7

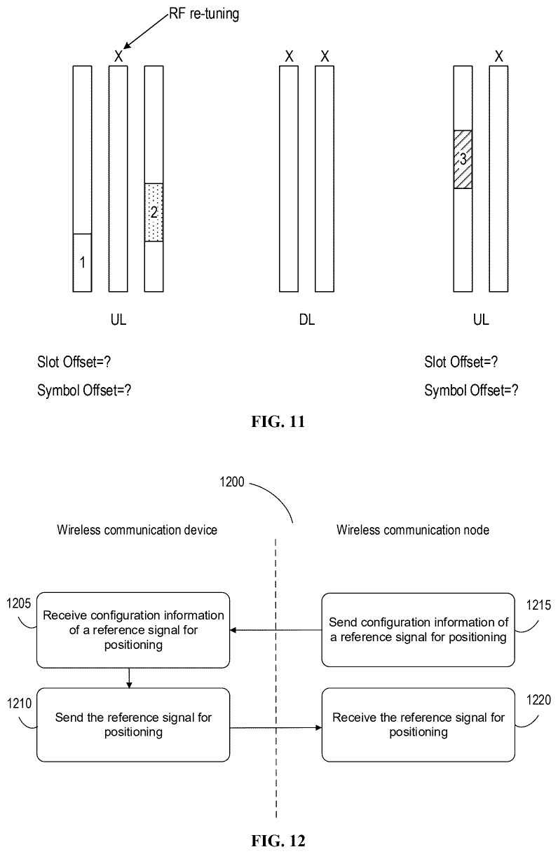

As FIG. 11, for a RedCap UE, a reference signal for positioning (e.g., sounding reference signal, SRS, positioning reference signal, PRS, sidelink positioning reference signal, SL-PRS) can be transmitted with hopping. The SRS can hop within a slot (e.g., intra-slot hopping) and/or between/among slots (e.g., inter-slot hopping). With intra-slot hopping and inter-slot hopping, the time duration between two adjacent hops may not be the same.

When a UE hops from one SRS transmission occasion to next SRS transmission occasion, it can re-tune its radio frequency (RF) chain (from one frequency to another). It will consume some time (e.g., 70 us, 140 us) for re-tuning. During re-tuning time (or switching time), a UE cannot transmit/receive signal. A UE can report its capability on whether it can perform intra-slot hopping for SRS. Alternatively, a UE can report its capability on whether it can perform intra-slot hopping for SRS under/after a specific RF re-tuning time.

A SRS transmission occasion can be associated/configured with a slot offset, symbol offset, start position, number of symbols, periodicity and corresponding offset, repetition factor, available slot offset list. Alternatively, a SRS transmission occasion with hopping can be associated/configured with a slot offset, symbol offset, number of symbols, periodicity and corresponding offset.

Alternatively, for an a period SRS, its transmission occasion with hopping can be configured with at least one of slot offset (e.g., 0, 1, 2, . . . , 100, relative to the slot for downlink control information, DCI), symbol offset or start position (e.g., 0, 1, 2, . . . , 13, in number of symbols), number of symbols. Alternatively, for the SRS transmission occasion after the first SRS transmission occasion, a slot offset and/or symbol offset can be configured. For example, for two slots containing SRS transmission occasion, one slot offset for the first SRS transmission occasion and another slot offset for the second SRS transmission occasion can be separately configured. For another example, for two slots containing SRS transmission occasion, one slot offset for the first SRS transmission occasion and another slot offset for the second SRS transmission occasion can be separately configured while the symbol offset can be identical. Alternatively, this can be applied when there is/are one/some downlink slot(s) between these two adjacent SRS transmission occasions (or between these two adjacent SRS hops).

Alternatively, for a period SRS/semi-period SRS, its transmission occasion with hopping can be configured with at least one of periodicity and corresponding offset (e.g. 10 slots of periodicity and 0 for offset), number of symbols. Alternatively, for each hop of SRS or each transmission occasion of SRS with hopping, a periodicity and corresponding offset is configured.

Alternatively, when there is/are one/some downlink slot(s) between these two adjacent SRS transmission occasions, this/these downlink slot(s) is/are not counted in the computation of slot offset. That is, only the uplink (UL) slot is counted when computing slot offset/periodicity.

Alternatively, these SRS transmission occasions (or, hops) can be divided into several groups (e.g., two groups). Each group can have an identical parameters (e.g., same symbol offset, same periodicity, same number of symbols). Parameters for different groups can be different.

For one specific RedCap UE, there is at least one symbol between two adjacent hops of SRS. Alternatively, for one specific RedCap UE, there is at least one symbol between two adjacent SRS transmission occasion with hopping. Alternatively, for one specific RedCap UE, there is at least CombSize symbol(s) between two adjacent SRS transmission occasion with hopping, where the CombSize is a Comb size of SRS (e.g., 1, 2, 3, 4, 6, 8, 12, 24, 36, 48). Alternatively, the symbol(s) between two adjacent SRS transmission occasion with hopping is/are not counted in the computation of symbol offset/start position. Alternatively, the symbol(s) between two adjacent SRS transmission occasion with hopping is/are not counted in the computation of real symbol location with symbol offset/start position.

For SRS with hopping, if the configured number of symbols is Q (e.g., Q=4), CombSize=2, and number of symbols for RF re-tuning is T (e.g., for SCS=30 kHz, T=2 for 70 us of RF re-tuning time), then there is at most floor ((Q−T)/CombSize)=floor ((4−2)/2)=1 SRS transmission occasion with hopping within this slot.

With this method, the hopping of SRS for RedCap UE is enabled which can improve positioning accuracy (because of forming a larger effective bandwidth, after hopping).

It should be understood that one or more features from the above implementation examples are not exclusive to the specific implementation examples, but can be combined in any manner (e.g., in any priority and/or order, concurrently or otherwise).

FIG. 12 illustrates a flow diagram of a method 1200 for positioning. The method 1200 may be implemented using any one or more of the components and devices detailed herein in conjunction with FIGS. 1-11. In overview, the method 1100 may be performed by a wireless communication device (e.g., a UE) or a wireless communication node (e.g., a BS or a gNB), in some embodiments. Additional, fewer, or different operations may be performed in the method 1200 depending on the embodiment. At least one aspect of the operations is directed to a system, method, apparatus, or a computer-readable medium.

A wireless communication device (e.g., a UE) may receive configuration information of a reference signal for positioning from a wireless communication node (e.g., a BS). The wireless communication device may send the reference signal for positioning to the wireless communication node. The configuration information may indicate that the wireless communication device is configured to report its capability on whether the wireless communication device can perform intra-slot hopping for sending the reference signal for positioning with a specific RF re-tuning time. The configuration information may indicates that an SRS transmission occasion with hopping is configured with at least one of: a slot offset, a symbol offset, a number of symbols, or a periodicity and a corresponding offset. The configuration information may indicate that, for two slots containing first and second SRS transmission occasion, respectively, a first slot offset for the first SRS transmission occasion and second slot offset for the second SRS transmission occasion are separately configured while their respective symbol offsets are identical to each other. The configuration information may indicate that, for each hop of SRS or each transmission occasion of SRS with hopping, a periodicity and a corresponding offset is configured.

In some embodiments, the configuration information may indicate that, for one specific RedCap UE, there is at least CombSize symbol(s) between two adjacent SRS transmission occasions with hopping or between two adjacent SRS hops, where the CombSize is a Comb size of an SRS. The configuration information may indicate that symbol(s) between two adjacent SRS transmission occasions with hopping is/are not counted in determining a starting position. The configuration information may indicate that, for an SRS with hopping, if a configured number of symbols is Q, and a number of symbols for RF re-tuning is T, then there is at most floor ((Q−T)/CombSize) SRS transmission occasions with hopping within a slot, where the CombSize is a Comb size of the SRS.

In some embodiments, a wireless communication device may receive a request for Rx hopping of a reference signal for positioning from a wireless communication node. The wireless communication device may perform the Rx hopping of the reference signal for positioning measurement. The reference signal for positioning can be a positioning reference signal (PRS). The measurement can be performed within a measurement period requirement. The measurement may include at least one of: RSTD; PRS-RSRP; UE Rx-Tx time difference; PRS-RSRPP; or carrier phase and/or carrier phase difference. The measurement period requirement can be related to at least one of: a factor H associated with hopping information; a factor H1 associated with hopping information within a PRS transmission; a factor H2 associated with a re-tunning time between adjacent hops; a factor H3 associated with a number of symbols between adjacent hops; a factor H4 associated with a number of symbols of each hop; a factor H5 associated with a PRS transmission occasion information; or a factor H6 associated with a measurement gap length and/or measurement gap repetition factor.

In some embodiments, the measurement period requirement can be determined based on the factor H associated with hopping information as: T_{meas,hop,Total}=H*T_{meas,Total} or T_{meas,hop,Total}=T_{meas,Total}+H. The measurement period in a positioning frequency layer i can be extended as: T_{meas,hop,i}=H*T_{meas,i} or T_{meas,hop,i}=T_{meas,i}+H, where meas is one of: RSTD, PRS-RSRP, UE Rx-Tx time difference, PRS-RSRPP or a carrier phase measurement; or the factor H is applied in determining the measurement period with the positioning frequency layer i. The factor H or hopping information can be a number of hops for a PRS resource. The factor H or hopping information can be related to a number of hops for a PRS resource. The factor H or hopping information can be configured by the wireless communication node. The factor H or hopping information can be reported by the wireless communication device.

In some embodiments, the measurement period requirement can be calculated according to the factor H and the factor H1 within the PRS transmission occasion. The measurement period can be calculated as: T_{meas,hop,Total}=H/H1*T_{meas,Total} or

T_{meas,hop,Total}=T_{meas,Total}+H/H1 or the measurement period in a positioning frequency layer i can be extended as: T_{meas,hop,i}=H/H1*T_{meas,i} or T_{meas,hop,i}=T_{meas,i}+H/H1. Alternatively, the above factor H/H1 can be replaced by floor (H/H1) in the previous equations. meas is one of: RSTD, PRS-RSRP, UE Rx-Tx time difference, PRS-RSRPP or a carrier phase measurement; or the factor H/H1 is applied in determining the measurement period with the positioning frequency layer i; or floor (H/H1) is applied in determining the measurement period with the positioning frequency layer i. The factor H1 or hopping information within a PRS transmission can be a number of hops within the PRS transmission occasion.

In some embodiments, the factor H1 or hopping information within a PRS transmission can be configured by the wireless communication node. The factor H1 or hopping information within a PRS transmission can be reported by the wireless communication device. The measurement period requirement can be calculated according to the factor H and the factor H2 or the factor H3. The measurement period can be calculated as: T_{meas,hop,Total}=H/H2*T_{meas,Total} or T_{meas,hop,Total}=T_{meas,Total}+H/H2 or T_{meas,hop,Total}=H/H3*T_{meas,Total} or T_{meas,hop,Total}=T_{meas,Total}+H/H3. The measurement period in a positioning frequency layer i can be extended as: T_{meas,hop,i}=H/H2*T_{meas,i} or T_{meas,hop,i}=T_{meas,i}+H/H2 or T_{meas,hop,i}=H/H3*T_{meas,i} or T_{meas,hop,i}=T_{meas,i}+H/H3. Alternatively, the above factor H/H2 or H/H3 can be replaced by floor (H/H2) or floor (H/H3). In certain embodiments, the above factor H2 or H3 can be replaced by S/H2 or S/H3, wherein S is the number of symbol configured for PRS. meas is one of: RSTD, PRS-RSRP, UE Rx-Tx time difference, PRS-RSRPP or a carrier phase measurement. The factor H/H2 or H/H3 can be applied in determining the measurement period with the positioning frequency layer i. Floor (H/H2) or floor (H/H3) can be applied in determining the measurement period with the positioning frequency layer i. S/H2 or S/H3 can be applied in determining the measurement period with the positioning frequency layer i. S is a number of symbol configured for PRS.

In some embodiments, the factor H2 or H3 or re-tunning time between adjacent hops or number of symbols between adjacent hops can be a number of symbols related to the re-tunning time. The factor H2 or H3 or re-tunning time between adjacent hops or number of symbols between adjacent hops can be configured by the wireless communication node. The factor H2 or H3 or re-tunning time between adjacent hops or number of symbols between adjacent hops is reported by the wireless communication device. The measurement period requirement can be calculated according to the factor H, the factor H2, and the factor H4. The measurement period can be calculated as: T_{meas,hop,Total}=H/(H2+H4)*T_{meas,Total} or T_{meas,hop,Total}=T_{meas,Total}+H/(H2+H4). The measurement period in a positioning frequency layer i can be expressed as: T_{meas,hop,i}=H/(H2+H4)*T_{meas,i} or T_{meas,hop,i}=T_{meas,i}+H/(H2+H4). Alternatively, the above factor H/(H2+H4) can be replaced by floor (H/(H2+H4)). In certain embodiments, the above factor H2+H4 can be replaced by S/(H2+H4), wherein S is the number of symbol configured for PRS. meas is one of: RSTD, PRS-RSRP, UE Rx-Tx time difference, PRS-RSRPP or a carrier phase measurement. The factor H/(H2+H4) can be applied in determining the measurement period with the positioning frequency layer i. Floor (H/(H2+H4)) can be applied in determining the measurement period with the positioning frequency layer i. S/(H2+H4) can be applied in determining the measurement period with the positioning frequency layer I, where S is a number of symbol configured for PRS.

In some embodiments, the factor H4 or number of symbols of each hop can be related to a configuration of a comb size. The factor H4 or number of symbols of each hop can be equal to or greater than the configuration of the comb size. The factor H4 or number of symbols of each hop can be reported by the wireless communication device. The factor H4 or number of symbols of each hop can be configured by the wireless communication node.

In some embodiments, the measurement period requirement can be calculated according to the factor H5, wherein the measurement period is calculated as: T_{meas,hop,Total}=H5*T_{meas,Total} or T_{meas,hop,Total}=T_{meas,Total}+H5 or the measurement period in a positioning frequency layer i can be expressed as T_{meas,hop,i}=H5*T_{meas,i} or T_{meas,hop,i}=T_{meas,i}+H5, where meas is one of: RSTD, PRS-RSRP, UE Rx-Tx time difference, PRS-RSRPP or a carrier phase measurement. The factor H5 can be applied in determining the measurement period with the positioning frequency layer i.

In some embodiments, the factor H5 or PRS transmission occasion information can be a number of PRS transmission occasions or a number of PRS transmission repetitions. The factor H5 or PRS transmission occasion information can be reported by the wireless communication device. The factor H5 or PRS transmission occasion information can be configured by the wireless communication node.

In some embodiments, the measurement period requirement can be calculated according to the factor H and/or the factor H6, wherein the period is calculated as: T_{meas,hop,Total}=H6*T_{meas,Total} or T_{meas,hop,Total}=T_{meas,Total}+H6 or the measurement period in a positioning frequency layer i can be expressed as: T_{meas,hop,i}=H6*T_{meas,i} or T_{meas,hop,i}=T_{meas,i}+H6. Alternatively, the above factor H6 can be replaced by H/H6 or floor (H/H6). meas is one of: RSTD, PRS-RSRP, UE Rx-Tx time difference, PRS-RSRPP or a carrier phase measurement. The factor H6 can be applied in determining the measurement period with the positioning frequency layer i. Alternatively, the above factor H6 can be replaced by H/H6 or floor (H/H6). The factor H6 can be related to a configuration of the measurement gap. The configuration of measurement gap may comprise a measurement gap length and/or a measurement gap period. The factor H6 can be reported by the wireless communication device. The factor H6 can be configured by the wireless communication node. The measurement period requirement can be related to a time-related requirement. The time-related requirement may include at least one of: a time limitation; or a parameter related to a configuration of a PRS; or a parameter related to a configuration of a measurement gap.

In some embodiments, the time-related requirement can be configured to define a measurement period requirement for frequency hopping PRS measurement. The time-related requirement can be configured by the wireless communication node.

In some embodiments, the measurement period requirement can be related a measurement capability of the wireless communication device. The measurement capability can be for frequency hopping PRS measurement. The measurement capability may indicate a duration Nₕₒₚ of DL-PRS symbols in units of ms that the wireless communication device can process every Tₕₒₚ ms assuming maximum DL-PRS bandwidth provided in supported BandwidthPRS for frequency hopping PRS measurement. The value of Nₕₒₚ can be configured smaller than a PRS processing capability without hopping, and the value of Tₕₒₚ can be larger than the PRS processing capability without hopping. Nₕₒₚ and Tₕₒₚ can be applied to the calculation of measurement period requirement. The measurement period of RSTD in positioning frequency layer i can be calculated as

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{avaiable \_ PRS , i}}{N} ⌉ * H 6 * {N}_{sample} - 1 ) * {T}_{effect , i} + {T}_{last , i} {T}_{effect , i} = ⌈ \frac{{T}_{hop}}{{T}_{avaiable \_ PRS , i}} ⌉ * {T}_{avaiable \_ PRS , i} .$$

In some embodiments, the measurement period requirement can be applied for RRC_CONNECTED state or RRC_INACTIVE or RRC_IDLE state. The request for Rx hopping may comprise a measurement requirement. The measurement requirement can be a measurement period requirement. The measurement requirement includes at least one of: a time limitation; or a parameter related to a configuration of a PRS; or a parameter related to a configuration of a measurement gap. The time limitation can be a time duration in unit of millisecond. The parameter related to a configuration of a PRS can be a number of PRS periodicities. The parameter related to a configuration of a measurement gap can be a number of measurement gap repetitions.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method for positioning, comprising:
receiving, by a wireless communication device from a wireless communication node, configuration information of a reference signal for positioning; and
sending, by the wireless communication device to the wireless communication node, the reference signal for positioning,
wherein the configuration information configures for the reference signal a plurality of sounding reference signal (SRS) transmission occasions with hopping.

2. The method according to claim 1, wherein the configuration information indicates that each of the SRS transmission occasions is configured with a corresponding slot offset and a corresponding symbol offset.

3. The method according to claim 2, wherein a first slot offset for a first SRS transmission occasion and a second slot offset for a second SRS transmission occasion are separately configured,
wherein a first symbol offset for the first SRS transmission occasion and a second symbol offset for the second SRS transmission occasion are separately configured, and wherein the second SRS transmission occasion is after the first SRS transmission occasion.

4. The method according to claim 1, wherein the configuration information indicates that SRS transmission occasions with hopping are configured with a periodicity.

5. The method according to claim 4, wherein the configuration information indicates that each of the SRS transmission occasions is configured with a corresponding offset.

6. A method for positioning, comprising:
sending, by a wireless communication node to a wireless communication device, configuration information of a reference signal for positioning; and
receiving, by the wireless communication node from the wireless communication device, the reference signal for positioning,
wherein the configuration information configures for the reference signal a plurality of sounding reference signal (SRS) transmission occasions with hopping.

7. The method according to claim 6, wherein the configuration information indicates that each of the SRS transmission occasions is configured with a corresponding slot offset and a corresponding symbol offset.

8. The method according to claim 7, wherein a first slot offset for a first SRS transmission occasion and a second slot offset for a second SRS transmission occasion are separately configured,
wherein a first symbol offset for the first SRS transmission occasion and a second symbol offset for the second SRS transmission occasion are separately configured, and
wherein the second SRS transmission occasion is after the first SRS transmission occasion.

9. The method according to claim 6, wherein the configuration information indicates that SRS transmission occasions with hopping are configured with a periodicity.

10. The method according to claim 9, wherein the configuration information indicates that each of the SRS transmission occasions is configured with a corresponding offset.

11. A wireless communication device, comprising:
at least one processor configured to:
receive, via a transceiver from a wireless communication node, configuration information of a reference signal for positioning; and
send, via the transceiver to the wireless communication node, the reference signal for positioning,
wherein the configuration information configures for the reference signal a plurality of sounding reference signal (SRS) transmission occasions with hopping.

12. The wireless communication device according to claim 11, wherein the configuration information indicates that each of the SRS transmission occasions is configured with a corresponding slot offset and a corresponding symbol offset.

13. The wireless communication device according to claim 12, wherein a first slot offset for a first SRS transmission occasion and a second slot offset for a second SRS transmission occasion are separately configured,
wherein a first symbol offset for the first SRS transmission occasion and a second symbol offset for the second SRS transmission occasion are separately configured, and
wherein the second SRS transmission occasion is after the first SRS transmission occasion.

14. The wireless communication device according to claim 11, wherein the configuration information indicates that SRS transmission occasions with hopping are configured with a periodicity.

15. The wireless communication device according to claim 14, wherein the configuration information indicates that each of the SRS transmission occasions is configured with a corresponding offset.

16. A wireless communication node, comprising:
at least one processor configured to:
send, via a transceiver to a wireless communication device, configuration information of a reference signal for positioning; and
receive, via the transceiver from the wireless communication device, the reference signal for positioning,
wherein the configuration information configures for the reference signal a plurality of sounding reference signal (SRS) transmission occasions with hopping.

17. The wireless communication node according to claim 16, wherein the configuration information indicates that each of the SRS transmission occasions is configured with a corresponding slot offset and a corresponding symbol offset.

18. The wireless communication node according to claim 17, wherein a first slot offset for a first SRS transmission occasion and a second slot offset for a second SRS transmission occasion are separately configured,
wherein a first symbol offset for a first SRS transmission occasion and a second symbol offset for a second SRS transmission occasion are separately configured, and
wherein the second SRS transmission occasion is after the first SRS transmission occasion.

19. The wireless communication node according to claim 16, wherein the configuration information indicates that SRS transmission occasions with hopping are configured with a periodicity.

20. The wireless communication node according to claim 19, wherein the configuration information indicates that each of the SRS transmission occasions is configured with a corresponding offset.
